(19) United States
(12) Patent Application Publication
(10) Pub. No.: US 2018/0313689 A1
(43) Pub. Date: Nov. 1, 2018

(54) RECEIVED-LIGHT AMOUNT MEASUREMENT SYSTEM

(71) Applicant: PANASONIC INTELLECTUAL PROPERTY MANAGEMENT CO., LTD., Osaka (JP)

(72) Inventors: Yuri FUJIWARA, Osaka (JP); Kazuhiro HATTA, Osaka (JP)

(73) Assignee: PANASONIC INTELLECTUAL PROPERTY MANAGEMENT CO., LTD., Osaka (JP)

(21) Appl. No.: 15/955,788

(22) Filed: Apr. 18, 2018

(30) Foreign Application Priority Data
Apr. 26, 2017 (JP) 2017-087608

(51) Int. Cl. G01J 1/42; G01J 1/02; G01J 1/44

(52) U.S. Cl. CPC G01J 1/4204; G01J 1/0204; G01J 1/0219; G01J 2001/444; G01J 1/44; G01J 2001/446; G01J 1/0271

(57) ABSTRACT

A received-light amount measurement system is provided. The received-light amount measurement system includes: a first device that is wearable and obtains a first amount of received light; and a controller that, obtains first information on the first amount of received light from the first device. When the first amount of received light is less than or equal to a first specified value, the controller calculates interpolation information for interpolating the first amount of received light during a time period in which the first amount of received light is less than or equal to the first specified value, and determines the interpolation information as an interpolated amount of received light obtained by the first device.

### CROSS REFERENCE TO RELATED APPLICATION

This application claims the benefit of priority of Japanese Patent Application Number 2017-087608 filed on Apr. 26, 2017, the entire content of which is hereby incorporated by reference.

### BACKGROUND

### 1. Technical Field

The present disclosure relates to a received-light amount measurement system.

### 2. Description of the Related Art

In recent years, exposure of a body to light for the purpose of adjusting the biological clock and regulating the biological rhythm has been introduced as one of methods for correcting the biological rhythm disturbance. The biological clock is adjusted by regulating the biological rhythm, and it is possible to awaken the body.

Conventionally, a lighting control system having a face-illuminance calculation unit for calculating face illuminance of a resident in a building has been disclosed (see, for example, Japanese Unexamined Patent Application Publication No. 2009-238652). In this lighting control system, the lighting is controlled until the face illuminance increases to a predetermined illuminance required to awaken the body.

### SUMMARY

When a lighting control such as a light output control or a light emission period control is performed according to an amount of light received by a user, the amount of received light has to be precisely measured with a sensor or the like. However, in the conventional lighting control system, it is difficult to precisely obtain the amount of received light. This is because, for example, the sensor overlapped with clothing, hair, etc., which block light, causes the measured amount of received light to be lower than the actual amount of received light, communication errors occur between the sensor and a terminal device for storing data on the amount of received light, or missing data occurs due to a dead battery.

In view of the above, an object of the present disclosure is to provide a received-light amount measurement system capable of precisely obtaining the amount of received light.

In order to achieve the above-described object, a received-light amount measurement system according to an aspect of the present disclosure includes: a first device that is wearable and obtains a first amount of received light; and a controller that obtains first information on the first amount of received light from the first device, in which when the first amount of received light is less than or equal to a first specified value, the controller calculates interpolation information for interpolating the first amount of received light during a time period in which the first amount of received light is less than or equal to the first specified value, and determines the interpolation information as an interpolated amount of received light obtained by the first device.

According to the present disclosure, it is possible to precisely obtain the amount of received light.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a schematic view illustrating a received-light amount measurement system according to an embodiment;

FIG. 2 is a block diagram illustrating a first wearable terminal and a first terminal device in the received-light amount measurement system according to the embodiment;

FIG. 3 is an explanatory diagram illustrating an altitude difference between the first terminal device and a second terminal device in the received-light amount measurement system according to the embodiment;

FIG. 4 is an image view illustrating the received-light amount measurement system according to the embodiment;

FIG. 5 is a flow chart illustrating the operation of the received-light amount measurement system according to the embodiment;

FIG. 6 is a flow chart illustrating the operation of calculating an amount of received light based on user subjective evaluation in a received-light amount measurement system according to variation 1 of the embodiment; and

FIG. 7 is a flow chart illustrating the operation of calculating an amount of received light based on user schedule information and position information in a received-light amount measurement system according to variation 2 of the embodiment.

### DETAILED DESCRIPTION OF THE EMBODIMENT

Hereinafter, embodiments of the present disclosure will be described with reference to the drawings. It should be noted that the subsequently-described embodiments each show a specific example of the present disclosure. Therefore, numerical values, shapes, materials, structural components, the arrangement and connection of the structural components, etc. shown in the following embodiments are mere examples, and are not intended to limit the scope of the present disclosure. Furthermore, among the structural components in the following embodiments, components not recited in the independent claim which indicates the broadest concept of the present disclosure are described as arbitrary structural components.

Moreover, “substantially” and “approximately” mean, for example in the case of “substantially the same”, not only exactly the same, but what would be recognized as essentially the same as well.

In addition, each of the diagrams is a schematic diagram and thus is not necessarily strictly illustrated. In each of the diagrams, substantially the same structural components are assigned with the same reference signs, and redundant descriptions will be omitted or simplified.

The following describes a received-light amount measurement system according to an embodiment of the present disclosure.

### Embodiment

### (Configuration)

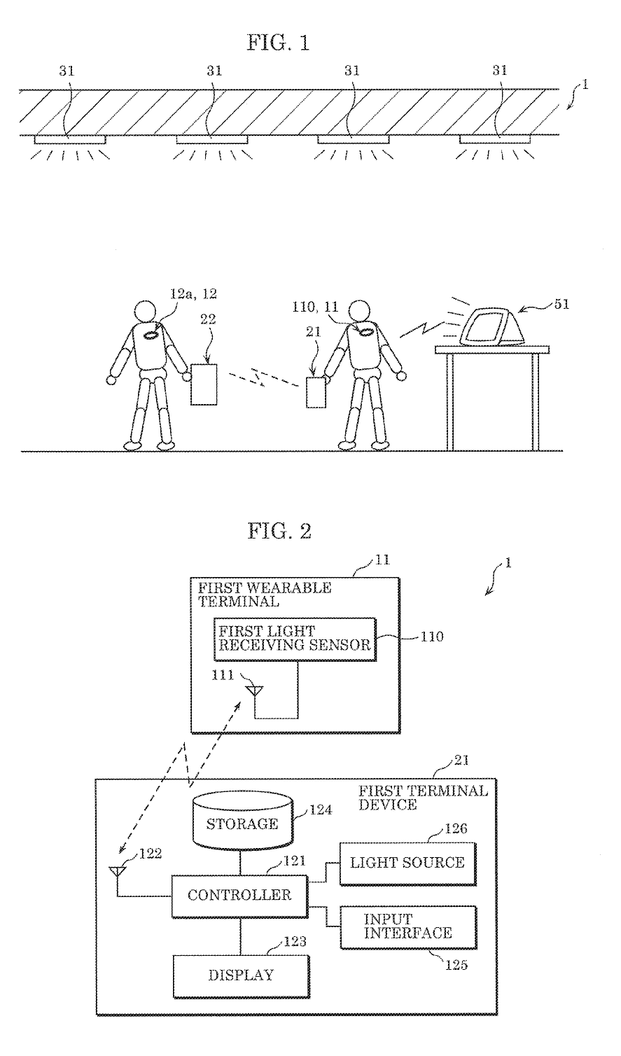

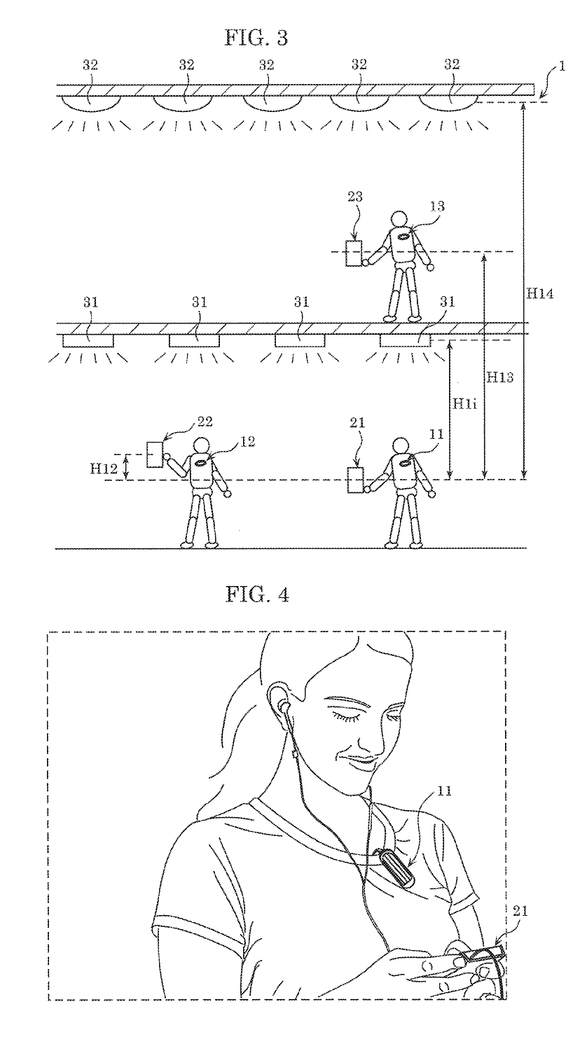

FIG. 1 is a schematic view illustrating received-light amount measurement system 1 according to the present embodiment. FIG. 2 is a block diagram illustrating first wearable terminal 11 and first terminal device 21 in received-light amount measurement system 1 according to the present embodiment. FIG. 3 is an explanatory diagram illustrating an altitude difference between first terminal device 21 and second terminal device 22 in received-light amount measurement system 1 according to the present embodiment. FIG. 4 is an image view illustrating received-light amount measurement system 1 according to the present embodiment.

As illustrated in FIG. 1, received-light amount measurement system 1 is capable of detecting an amount of light received by a user. Received-light amount measurement system 1 includes first wearable terminal 11 and first terminal device 21. Moreover, received-light amount measurement system 1 according to the present embodiment also includes second wearable terminal 12, second terminal device 22, two or more lighting apparatuses 31, and light-irradiating apparatus 51.

As illustrated in FIG. 4, first wearable terminal 11 is mounted on the clothing of a user to detect an amount of light received by the user, for example. First wearable terminal 11 and first terminal device 21 can communicate with each other. Typically, first wearable terminal 11 is mounted on the neckline, etc., which is close to the face. First wearable terminal 11 is an example of the first device.

As illustrated in FIG. 1 and FIG. 2, first wearable terminal 11 includes first light receiving sensor 110 and first communication circuit 111.

First light receiving sensor 110 includes a light receiving element such as a photodiode, and can detect the first amount of received light. In other words, first wearable terminal 11 obtains the first amount of received light through first light receiving sensor 110. First light receiving sensor 110 transmits information on the detected first amount of received light (an example of the first information) to first terminal device 21 via first communication circuit 111. Here, the amount of received light is calculated by multiplying brightness by light receiving period. In other words, the amount of received light is an accumulation of light received during a predetermined time period. First light receiving sensor 110 is an example of the first device.

First communication circuit 111 is, for example, an antenna for transmitting the information on the first amount of received light to first wearable terminal 11.

First terminal device 21 is a device such as a smartphone or a tablet terminal, and includes controller 121, second communication circuit 122, display 123, storage 124, input interface 125, and light source 126.

Controller 121 obtains the information on the first amount of received light from first light receiving sensor 110. In other words, controller 121 receives, via second communication circuit 122, the information on the first amount of received light transmitted from first wearable terminal 11, and calculates the amount of light received by the user. Specifically, controller 121 is implemented by a processor, a microcomputer, a dedicated circuit, or the like. Moreover, controller 121 may be implemented by a combination of a processor, a microcomputer, and a dedicated circuit.

Controller 121 obtains the first position information via second communication circuit 122 using a function such as a GPS function of first terminal device 21. The first position information strictly refers to the position of first terminal device 21. However, first wearable terminal 11 is disposed in the vicinity of first terminal device 21, and thus the first position information of first terminal device 21 is regarded as the first position information of first wearable terminal 11. In addition, the second position information of second terminal device 22 is regarded as the second position information of second wearable terminal 12 as well. Controller 121 stores, on storage 124, the first amount of received light received from first wearable terminal 11 in association with the first position information of first terminal device 21 which corresponds to the first amount of received light.

Controller 121 may obtain the second position information of an external device which exists in the vicinity of first terminal device 21. The external device is, for example, at least one of second terminal device 22, lighting apparatus 31, a light receiving sensor for detecting ambient brightness, light-irradiating apparatus 51, and the like. First position information includes not only the position of first terminal device 21 but also information the height relative to sea level. Second position information also includes not only the position of the external device but also information on the height relative to sea level.

When the first amount of received light is less than or equal to the first specified value, controller 121 calculates interpolation information for interpolating the first amount of received light during a time period in which the first amount of received light is less than or equal to the first specified value, and determines the interpolation information as an amount of received light detected by first light receiving sensor 110.

Specifically, controller 121 determines whether or not the first amount of received light received from first wearable terminal 11 is greater than the first specified value. When the first amount of received light received from first wearable terminal 11 is greater than the first specified value, it is determined that first light receiving sensor 110 can normally receive light, and controller 121 determines the received first amount of received light as an amount of light actually received by the user. In other words, the first amount of received light is regarded as the interpolation information. Here, “can normally receive light” means that first light receiving sensor 110 can correctly receive light without being overlapped with clothing, hair, etc., which block light.

Moreover, when the first amount of received light received from first wearable terminal 11 is less than or equal to the first specified value, it is determined that first light receiving sensor 110 may fail to normally receive light, and controller 121 determines whether or not the fourth amount of received light, which is received from first wearable terminal 11 during a specified time period including a point at which the first amount of received light is less than or equal to the first specified value, is greater than the first specified value. In other words, controller 121 searches storage 124 to determine whether or not the amount of received light exists which is greater than the first specified value during the specified time period around, i.e., including, the point at which the first amount of received light is less than or equal to the first specified value. Controller 121 identifies the fourth amount of received light which is greater than the first specified value during the specified time period.

Moreover, controller 121 calculates the third distance between the first positions based on (i) the first position information of first terminal device 21 at a point which is during the specified time period and (ii) the first position information of first terminal device 21 at a point, at which the identified fourth amount of received light is greater than the first specified value. When the third distance is less than the third specified distance, controller 121 determines the fourth amount of received light which is greater than the first specified value, as the amount of light actually received by the user. In other words, the fourth amount of received light is determined as the interpolation information. Here, controller 121 stores, on storage 124, the first amount of received light received from first wearable terminal 11 in association with the first position information of first terminal device 21 which corresponds to the first amount of received light.

It should be noted that when the fourth amount of received light appears several times during the specified time period, controller 121 may select the fourth amount of received light obtained at the point closest to the point at which the first amount of received, light is less than or equal to the first specified value, or may select the highest or lowest fourth amount of received light.

When all the first amounts of received light received from first wearable terminal 11 are less than or equal to the first specified value during the specified time period, controller 121 determines whether or not second terminal device 22 is activated. Specifically, controller 121 determines whether or not second terminal device 22 is activated, based on whether or not to communicate with second terminal device 22. For example, when controller 121 sends information to second terminal device 22 and receives a response, it may be determined that first terminal device 21 can communicate with second terminal device 22.

Here, it should be noted that when first terminal device 21 exits within a communication distance in which first terminal device 21 can obtain information from other terminal devices, controller 121 may select the terminal device closest to first terminal device 21 or the terminal device having the highest amount of received light. For example, controller 121 identifies the terminal device closest to first, terminal device 21 or the terminal device having the highest amount of received light based on the position information of each of the terminal devices.

As illustrated in FIG. 2 and FIG. 3, when it is determined that second terminal device 22 is activated, controller 121 obtains information on a radio field intensity and the second position information from second terminal device 22. Controller 121 calculates the first distance between second terminal device 22 and first terminal device 21 based on the first position information of first terminal device 21 and the second position information received from second terminal device 22, and also calculates altitude difference H12 based on the altitude of first terminal device 21 (an example of the first altitude) and the altitude of second terminal device 22 (an example of the second altitude). Moreover, controller 121 obtains the information on the radio field intensity of the communication circuit in second terminal device 22. For example, the radio field intensity can be used to assume whether the user is near the window, outside the room, in the recessed portion of the facility, or the like. When the radio field intensity is strong, it is assumed that the user is near the window and his/her surroundings are easy to receive light. Moreover, when the radio field intensity is weak, it is assumed that the user is in the recessed portion of the facility and his/her surroundings are difficult to receive light.

Controller 121 determines whether or not at least one of conditions that (i) the radio field intensity of second terminal device 22 is higher than or equal to the specified intensity level, (ii) the first distance is less than or equal to the first specified distance, and (iii) altitude difference H12 is less than or equal to the first specified height is satisfied. When at least one of the conditions that (i) the radio field intensity of second terminal device 22 is higher than or equal to the specified intensity level, (ii) the first distance is less than or equal to the first specified distance, and (iii) altitude difference H12 is less than or equal to the first specified height is satisfied, controller 121 calculates a difference between the second amount of received light received by second terminal device 22 from second wearable terminal 12 and the first amount of received light received by first terminal device 21 from first wearable terminal 11. The first specified height is an example of the specified height.

Controller 121 determines whether or not the difference is less than or equal to the second specified value. When the difference is less than or equal to the second specified value, controller 121 determines the first amount of received light as the amount of light actually received by the user. In other words, controller 121 determines the first amount of received light detected by first wearable terminal 11 as the interpolation information since there is no large difference between the first amount of received light and the second amount of received light.

Moreover, when the difference is more than the second specified value, controller 121 determines the second amount of received light as the amount of light actually received by the user. In other words, controller 121 determines second amount of received light as the interpolation information since there is a large difference between the first amount of received light and the second amount of received light. In other words, controller 121 obtains information on the amount of received light (an example of the second information) from second terminal device 22 which is an external device, and determines the amount of received light of second terminal device 22 as the interpolation information.

Moreover, when all the conditions that (i) the radio field intensity of second terminal device 22 is higher than or equal to the specified intensity level, (ii) the first distance is less than or equal to first specified distance c1, and (iii) altitude difference H12 is less than or equal to the first specified height are not satisfied, controller 121 calculates the second distance between lighting apparatus 31 and first terminal device 21, and also calculate altitude difference H1i based on the altitude of lighting apparatus 31 (an example of the second altitude) and the altitude of first terminal device 21 (an example of the first altitude). Specifically, controller 121 determines whether or not lighting apparatus 31 exists which satisfies at least one of conditions that (i) the second distance is less than or equal to the second specified distance and (ii) altitude difference H1i is less than or equal to the second specified height. In other words, controller 121 determines whether or not lighting apparatus 31 is located on the same floor as first terminal device 21, for example.

Controller 121 determines the third amount of received light obtained from lighting apparatus 31, as the interpolation information, based on the first position information of first terminal device 21 and the second position information of lighting apparatus 31. In other words, controller 121 obtains the information on the amount of received light (an example of the second information) from lighting apparatus 31 which is an external device, and determines the amount of received light of lighting apparatus 31 as the interpolation information. Specifically, when lighting apparatus 31 exists which satisfies at least one of the conditions that (i) the second distance is less than or equal to the second specified distance and (ii) altitude difference H1i is less than or equal to the second specified height, controller 121 calculates the third amount of received light from the light output of lighting apparatus 31 and the light emission period of lighting apparatus 31, and determines the third amount of received light as the interpolation information. The third amount of received light can be obtained by multiplying the light output of lighting apparatus 31 by the light emission period of lighting apparatus 31. The second specified height is an example of the specified height.

As illustrated in FIG. 3, lighting apparatuses 32 and a user having the third wearable terminal 13 and third terminal device 23 are located on a floor different from that of first terminal device 21, for example. The altitude difference between third terminal device 23 and first terminal device 21 is denoted as H13. The altitude difference between lighting apparatus 32 and first terminal device 21 is denoted as H14. In this case, each floor has a different lighting environment, and thus first specified distance c1, second specified distance c2, the first specified height, and the second specified height are set so as not to obtain the information on the amount of received light (an example of the second information) from third terminal device 23 or lighting apparatus 32 located on a different floor.

As illustrated in FIG. 1 and FIG. 2, controller 121 determines whether or not light source 126 in first terminal device 21 is emitting light. Controller 121 obtains the light output of light source 126 in first terminal device 21, calculates the fifth amount of received light by multiplying the light output by the light emission period in which light source 126 emits light, and determines a result obtained by adding the fifth amount of received light to the interpolation information, as the amount of received light detected by first light receiving sensor 110 for a predetermined time period. The amount of light received by the user from light source 126 in first terminal device 21 is added, and thus controller 121 can precisely obtain the amount of received light.

Controller 121 controls at least one of lighting apparatus 31, light-irradiating apparatus 51, and the like. Specifically, for example, controller 121 determines whether or not the amount of light received in a day by a user satisfies the amount of received light needed daily which is stored in storage 124. When it is determined that the amount of received light needed daily is not satisfied, controller 121 controls lighting apparatus 31, light-irradiating apparatus 51, etc., such that the user can receive the amount of light needed daily. In other words, controller 121 transmits, to lighting apparatus 31, light-irradiating apparatus 51, etc., a command such as turning on lighting apparatus 31, light-irradiating apparatus 51, etc., or increasing the light output of lighting apparatus 31, light-irradiating apparatus 51, etc. Lighting apparatus 31, light-irradiating apparatus 51, etc., receive this command and perform a predetermined operation. Moreover, even when it is determined that the amount of received light needed daily is satisfied, controller 121 transmits, to lighting apparatus 31, light-irradiating apparatus 51, etc., a command such as turning off of lighting apparatus 31, light-irradiating apparatus 51, etc., or decreasing of the light output of lighting apparatus 31, light-irradiating apparatus 51, etc.

Based on the second position information obtained from the external device such as lighting apparatus 31, light-irradiating apparatus 51, etc., when the altitude of first terminal device 21 is different from the altitudes of lighting apparatus 31, light-irradiating apparatus 51, etc., i.e. when their floors are different in a building, controller 121 need not control lighting apparatus 31, light-irradiating apparatus 51, etc. The determination on whether or not first terminal device 21 is located on a different floor from lighting apparatus 31, light-irradiating apparatus 51, etc. can be implemented by calculating the altitude difference based on the first position information of first terminal device 21 and the second position information of lighting apparatus 31, light-irradiating apparatus 51, etc., and determining that their floors are different in the building when the altitude difference is more than or equal to the specified height.

It should be noted that light-irradiating apparatus 51 is for exposing a user to light, but not limited to an apparatus for causing the user to receive light actively. A normal lighting apparatus is possible.

Second communication circuit 122 is, for example, an antenna for obtaining the information on the first amount of received light transmitted from first wearable terminal 11. The information obtained by second communication circuit 122 is provided to controller 121. It should be noted that first communication circuit 111 and second communication circuit 122 according to the present embodiment may be wirelessly communicated with each other using a wireless communication standard such as or Long Term Evolution (LTE). Moreover, first communication circuit 111 and second communication circuit 122 may be connection terminals, and second communication circuit 122 may receive information on the first amount of received light via a communication cable.

Display 123 is, for example, a liquid crystal display, and uses an output from controller 121 to display information such as the amount of light received in a day. Display 123 is an example of a terminal device. The terminal device is not limited to display 123, and may inform the surrounding people by emitting sound from a speaker, for example.

Storage 124 is a storage which stores a control program executed by controller 121. For example, storage 124 stores the amount of received light at daily or predetermined intervals. Moreover, storage 124 also stores, for example, the first position information and the second position information corresponding to the first to fifth amounts of received light. Taking the first amount of received light as an example, storage 124 stores it in association with the corresponding first position information at predetermined intervals. For example, storage 124 is implemented as a semiconductor memory.

Input interface 125 is, for example, a touch panel, and functions as a user interface for receiving an instruction from a user. Input interface 125 can cause first light receiving sensor 110 in first wearable terminal 11 to start and end to receive light.

Light source 126 may be, as they are called, a surface mount device (SMD) or chip on hoard (COB) LED element. It should be noted that light source 126 may be a liquid crystal panel used as display 123, or another light emitting element including an electro luminescence (EL) element such as an organic EL or an inorganic EL. Accordingly, light source 126 is not a necessary structural component.

Second wearable terminal 12 is mounted on the clothing of another person to detect an amount of light received by the another person, for example. Second wearable terminal 12 includes second light receiving sensor 12a which can detect the second amount of received light, and a communication circuit which can communicate with second terminal device 22. Second wearable terminal 12 transmits, to second terminal device 22, information on the amount of light received by the another person. In the present embodiment, second wearable terminal 12 and first wearable terminal 11 have the same configuration, but may have a different configuration as long as the information on the amount of light received by the another person can be obtained. Each of second wearable terminal 12 and second light receiving sensor 12a is an example of the second device.

In order to transmit the second amount of received light to first terminal device 21, the controller of second terminal device 22 store, in a storage, the second amount of received light in association with the corresponding second position information of second terminal device 22 and the corresponding radio field intensity of second terminal device 22. The controller of second terminal device 22 transmits the second amount of received light, the second position information, and the radio field intensity in response to a request from first terminal device 21. It should be noted that for the case of transmission to other terminal, devices, first terminal device 21 also stores, in a storage, the first amount of received light in association with the corresponding first position information of first terminal device 21 and the corresponding radio field intensity of first terminal device 21.

Moreover, second terminal device 22 is a terminal device different from first terminal device 21, and is implemented as, for example, a smartphone or a tablet terminal. Second terminal device 22 transmits the information on the amount of received light detected by second wearable terminal 12 to first terminal device 21 in response to a request from first terminal device 21. In the present embodiment, second terminal device 22 and first terminal device 21 have the same configuration, but may have a different configuration.

### (Operation)

Next, the operation of received-light amount measurement system 1 will be described.

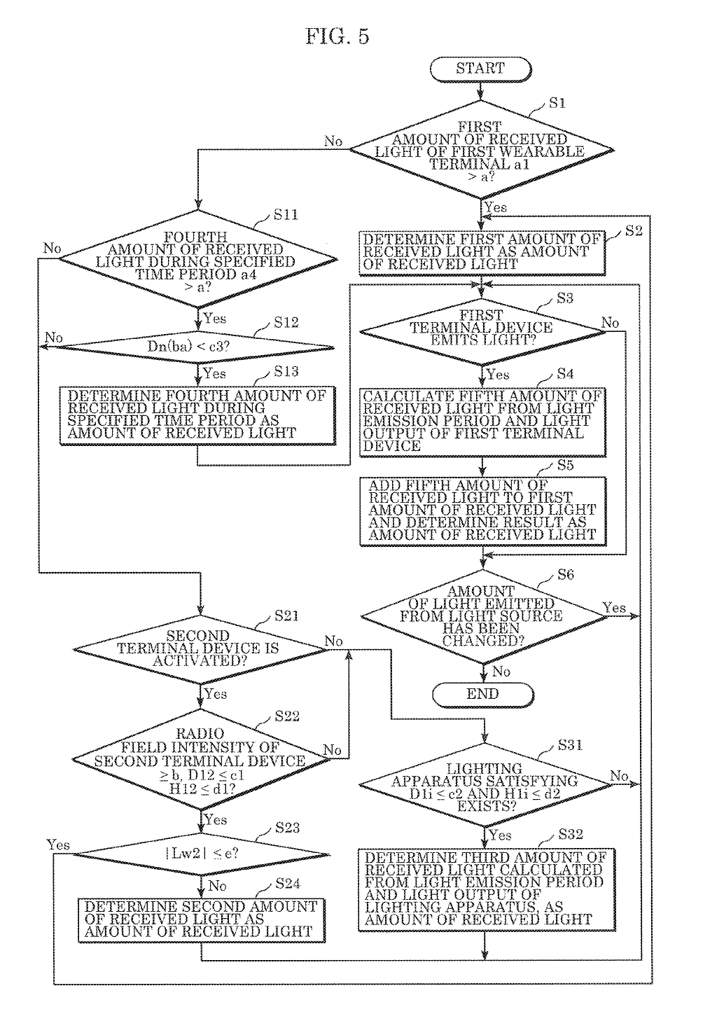

FIG. 5 is a flow chart illustrating the operation of received-light amount measurement system 1 according to the present embodiment.

A user activates first wearable terminal 11 to start to detect an amount of received light, and launches an application dedicated to measure the amount of received light in first terminal device 21. In this manner, the user starts to measure the amount of light received by the user.

First, first wearable terminal 11 continuously or discretely transmits information on first amount of received light a1 received by first light receiving sensor 110 to first terminal device 21. Controller 121 of first terminal device 21 determines whether or not first amount of received light a1 received from first wearable terminal 11 is greater than first specified value a (S1).

When it is determined that first amount of received light a1 received from first wearable terminal 11 is greater than first specified value a (Yes at S1), controller 121 determines the received first amount of received light a1 as an amount of light actually received by the user (S2). In other words, controller 121 determines first amount of received light a1 as interpolation information, and also determines the interpolation information as an amount of received light detected by first light receiving sensor 110.

Next, controller 121 determines whether or not first terminal device 21 is emitting light (S3). Specifically, controller 121 determines whether or not light source 126 in first terminal device 21 is emitting light (S3). It should be noted that at Step S3, controller 121 may determine whether or not at least one of light source 126 and display 123 is emitting light.

When it is determined that first terminal device 21 is emitting light (Yes at S3), controller 121 calculates the fifth amount of received light based on the light emission period of first terminal device 21 and the light output of light source 126 in first terminal device 21 (S4). It should be noted that at Step S4, controller 121 may calculate the fifth amount of received light based on the light output of at least one of light source 126 and display 123.

Next, controller 121 adds the fifth amount of received light to the first amount of received light a1, and determines the result as the amount of light actually received by the user (S5). In other words, controller 121 determines the fifth amount of received light as the interpolation information, and also determines the interpolation information as the amount of received light detected by first light receiving sensor 110.

Next, controller 121 determines whether or not an amount of light emitted from light source 126 in first terminal device 21 has been changed by the user (S6).

When it is determined that the amount of light emitted from first terminal device 21 has been changed (Yes at S6), processing returns to Step S3 and controller 121 repeats the determination. For example, the case is considered in which the operation of changing the amount of light emitted from light source 126, such as the operation of increasing or decreasing the amount of light emitted from first terminal device 21, has been performed.

It should be noted that controller 121 causes display 123 to display the amount of light actually received by the user. Moreover, a time point when controller 121 causes display 123 to display the amount of received light is not limited to this point, and may cause display 123 to display it at other steps.

Moreover, when it is determined that first terminal device 21 emits no light (No at S3), processing proceeds to Step S6 and controller 121 performs the process.

On the other hand, when it is determined that the amount of light emitted from first terminal device 21 is not changed (No at S6), controller 121 may cause display 123 to display a current (actual) amount of received light. Then, controller 121 exits the processing. Moreover, processing can be stopped at any time by user operations such as closing the application of first terminal device 21 and turning off first terminal device 21.

Moreover, when it is determined that first amount of received light a1 received from first wearable terminal 11 is less than or equal to first specified value a (No at S1), controller 121 determines whether or not fourth amount of received light a4, which is received from first wearable terminal 11 during specified time period M including a point at which first amount of received light a1 is less than or equal to first specified value a, is greater than first specified value a (S11).

When it is determined that fourth amount of received light a4 received from first wearable terminal 11 during specified time period M is greater than first specified value a (Yes at S11), controller 121 calculates third distance Dn(ba) between the first positions based on (i) the first position information of first terminal device 21 at a point at which first amount of received light a1 is less than or equal to first specified value a and (ii) the first position information of first terminal device 21 at a point at which fourth amount of received light a4 is greater than first specified value a. Then, controller 121 determines whether or not the calculated third distance Dn(ba) is less than third specified distance c3 (S12).

When it is determined that third distance Dn(ba) is less than third specified distance c3 (Yes at S12), controller 121 determines fourth amount of received light a4 during specified time period M as the amount of light actually received by the user (S13). In other words, controller 121 determines fourth amount of received light a4 as the interpolation information, and also determines the interpolation information as the amount of received light detected by first light receiving sensor 110. Then, processing proceeds to Step S3 and controller 121 performs the process.

On the other hand, when it is determined that third distance Dn(ba) is larger than third specified distance c3 (No at S12), processing proceeds to Step S21 described below and controller 121 performs the process.

When it is determined that fourth amount of received light a4 received from first wearable terminal 11 during specified time period M is less than or equal to first specified value a (No at S11), controller 121 determines whether or not second terminal device 22 is activated (S21).

When it is determined that second terminal device 22 is activated (Yes at S21), controller 121 obtains information on a radio field intensity and position information from second terminal device 22. Controller 121 calculates first distance D12 between second terminal device 22 and first terminal device 21 and altitude difference H12 between first terminal device 21 and second terminal device 22, based on the first position information received from first terminal device 21 and the second position information received from second terminal device 22. Controller 121 determines whether or not the conditions that (i) the radio field intensity of second terminal device 22 is higher than or equal to specified intensity level b, (ii) first distance D12 is less than or equal to first specified distance c1, and (iii) altitude difference H12 is less than or equal to first specified height d1 are satisfied (S22). It should be noted that at Step S22, all the conditions that (i) the radio field intensity is higher than or equal to specified intensity level b, (ii) first distance D12 is less than or equal to first specified distance c1, and (iii) altitude difference H12 is less than or equal to first specified height d1 should be satisfied, but at least one of them may be satisfied.

When it is determined that the conditions that (i) the radio field intensity of second terminal device 22 is higher than or equal to specified intensity level b, (ii) first distance D12 between second terminal device 22 and first terminal device 21 is less than or equal to first specified distance e1, and (iii) altitude difference H12 is less than or equal to first specified height d1 are satisfied (Yes at S22), controller 121 calculates difference |Lw2| between the second amount of received light received by second terminal device 22 from second wearable terminal 12 and first amount of received light a1 received by first terminal device 21. Controller 121 determines whether or not the calculated difference |Lw2| is less than or equal to second specified value e (S23).

On the other hand, when controller 121 determines that the conditions that (i) the radio field intensity of second terminal device 22 is higher than or equal to specified intensity level b, (ii) first distance D12 between second terminal device 22 and first terminal device 21 is less than or equal to first specified distance c1, and (iii) altitude difference H12 is less than or equal to first specified height d1 are not satisfied (No at S22), processing proceeds to Step S31 described below.

When it is determined that the calculated difference |Lw2| is less than or equal to second specified value e (Yes at S23), processing proceeds to Step S2 and controller 121 determines first amount of received light a1 as the amount of light actually received by the user. In other words, controller 121 determines first amount of received light a1 as the interpolation information, and also determines the interpolation information as the amount of received light detected by first light receiving sensor 110.

On the other hand, when it is determined that the calculated difference |Lw2| is more than second specified value e (No at S23), controller 121 determines the second amount of received light as the amount of light actually received by the user (S24). In other words, controller 121 determines the second amount of received light as the interpolation information, and also determines the interpolation information as the amount of received light detected by first light receiving sensor 110. Then, processing proceeds to Step S3 and controller 121 performs the process.

Moreover, at Step S21, when it is determined that second terminal device 22 is not activated (No at S21), controller 121 determines whether or not lighting apparatus 31 exists which satisfies the conditions that second distance D1i between lighting apparatus 31 and first terminal device 21 is less than or equal to second specified distance c2 and (ii) altitude difference H1i between lighting apparatus 31 and first terminal device 21 is less than or equal to second specified height d2 (S31). It should be noted that at Step S31, all the conditions that (i) second distance D1i is less than or equal to second specified distance c2 and (ii) altitude difference H1i is less than or equal to second specified height d2 should be satisfied, but at least one of them may be satisfied.

When it is determined that lighting apparatus 31 exists which satisfies the conditions that (i) second distance D1i between lighting apparatus 31 and first terminal device 21 is less than or equal to second specified distance c2 and (ii) altitude difference H1i between lighting apparatus 31 and first terminal device 21 is less than or equal to second specified height d2 (Yes at S31), controller 121 calculates the third amount of received light from the light output and the light emission period of lighting apparatus 31 which satisfies the conditions, and determines the third amount of received light as the amount of light actually received by the user (S32). In other words, controller 121 determines the third amount of received light obtained from lighting apparatus 31, as the interpolation information based on the first position information of first light receiving sensor 110 and the second position information of lighting apparatus 31, and also determines the interpolation information as the amount of received light detected by first light receiving sensor 110. It should be noted that controller 121 may obtain the amount of received light from a light receiving sensor included in lighting apparatus 31. Alternatively, controller 121 may obtain the amount of received light from a controller included in lighting apparatus 31 via a communication circuit in lighting apparatus 31. The method for obtaining the third amount of received light is not particularly limited. Then, processing proceeds to Step S3 and controller 121 performs the process.

On the other hand, when it is determined that the conditions that (i) second distance D1i between lighting apparatus 31 and first terminal device 21 is less than or equal to second specified distance c2 and (ii) altitude difference H1i between lighting apparatus 31 and first terminal device 21 is less than or equal to second specified height d2 are not satisfied (No at S31), processing proceeds to Step S3 and controller 121 performs the process.

### Advantageous Effect

Next, the advantageous effect of received-light amount measurement system 1 according to the present embodiment will be described.

As described above, received-light amount measurement system 1 according to the present embodiment includes: first light receiving sensor 110 that is wearable and obtains a first amount of received light; and controller 121 that obtains the first information on the first amount of received light from first light receiving sensor 110. When the first amount of received light is less than or equal to a first specified value, controller 121 calculates interpolation information for interpolating the first amount of received light during a time period in which the first amount of received light is less than or equal to the first specified value, and determines the interpolation information as an interpolated amount of received light obtained by first light receiving sensor 110.

In this manner, when the first amount of received light obtained from first light receiving sensor 110 is less than or equal to the first specified value, controller 121 calculates the interpolation information for interpolating the first amount of received light during the time period in which the first amount of received light is less than or equal to the first specified value. Then, controller 121 determines the interpolation information as the amount of received light detected by first light receiving sensor 110. Thus, even if first light receiving sensor 110 overlapped with clothing, hair, etc., which block light, causes the measured amount of received light to be lower than the actual amount of received light, communication errors occur between first light receiving sensor 110 and first terminal device 11 for storing data on the amount of received light, or missing data occurs due to dead batteries of first light receiving sensor 110 and first terminal device 11, the amount of received light can be interpolated during the above time period.

Accordingly, in received-light amount measurement system 1, it is possible to precisely obtain the amount of received light.

Moreover, in received-light amount measurement system 1 according to present embodiment, controller 121 obtains the second information on an amount of received light from an external device, and determines the amount of received light from the external device as the interpolation information.

In this manner, even if a time period exists in which the first amount of received light detected by first light receiving sensor 110 is less than or equal to the first specified value, controller 121 obtains the second information on the amount of received light of the external device and determines this amount of received light as the interpolation information. Accordingly, this amount of received light can be used for the interpolation during the time period in which the first amount of received light is less than or equal to the first specified value. For example, the information on the second amount of received light (an example of the second information) is obtained from second terminal device 22, and thus the second amount of received light can be used for the interpolation during the time period in which the first amount of received light is less than or equal to the first specified value. Moreover, for example, the information on the third amount of received light (an example of the second information) is obtained from lighting apparatus 31, and thus the third amount of received light can be used for the interpolation during the time period in which the first amount of received light is less than or equal to the first specified value. Accordingly, in received-light amount measurement system 1, it is possible to precisely obtain the amount of light received by the user.

Moreover, in received-light amount measurement system 1 according to the present embodiment, the external device is at least one of second light receiving sensor 12a that obtains a second amount of received light and lighting apparatus 31 that illuminates a space.

With this configuration, even if a time period exists in which the first amount of received light detected by first light receiving sensor 110 is less than or equal to the first specified value, second light receiving sensor 12a detects the second amount of received light, and thus at least one of the second amount of received light and the third amount of received light can be obtained from the external device for the interpolation during the time period in which the first amount of received light is less than or equal to the first specified value. Accordingly, in received-light amount measurement system 1, it is possible to precisely obtain the amount of light received by the user.

Moreover, in received-light amount measurement system 1 according to the present embodiment, when the external device is the second device, controller 121 calculates a first distance between first light receiving sensor 110 and the second device based on the first position information of first light receiving sensor 110 and the second position information of the second device, calculates an altitude difference between first light receiving sensor 110 and the second device from an altitude of first light receiving sensor 110 (an example of the first altitude) and an altitude of the second device (an example of the second altitude), and obtains a radio field intensity of the second device from the second device. And, when at least one of conditions is satisfied, controller 121 determines the second amount of received light of the second device as the interpolation information, and the conditions includes: the first distance being less than or equal to a first specified distance; the altitude difference being less than or equal to a specified height; and the radio field intensity being higher than or equal to a specified intensity level.

With this configuration, controller 121 determines the second amount of received light as the interpolation information based on the first distance between first light receiving sensor 110 and second terminal device 22 which is an example of the second device, altitude difference H12, and the radio field intensity of second terminal device 22, and thus it is possible to prevent the second amount of received light from being determined as the interpolation information when second terminal device 22 is far away from first light receiving sensor 110, e.g. when second terminal device 22 and first light receiving sensor 110 are located on different floors.

Accordingly, in received-light amount measurement system 1, it is possible to precisely obtain the amount of light received by the user.

Moreover, in received-light amount measurement system 1 according to the present embodiment, controller 121 further calculates a difference between the first amount of received light and the second amount of received light, when the difference between the first amount of received light and the second amount of received light is less than or equal to a second specified value, controller 121 determines the first amount of received light as the interpolation information, and when the difference between the first amount of received light and the second amount of received light is more than the second specified value, controller 121 determines the second amount of received light as the interpolation information.

In this manner, even if a time period exists in which the first amount of received light detected by first light receiving sensor 110 is less than or equal to the first specified value, controller 121 determines the first amount of received light as the interpolation information when the difference between the first amount of received light and the second amount of received light is less than or equal to the second specified value. Moreover, when the difference is more than the second specified value, the second amount of received light is determined as the interpolation information. Accordingly, in received-light amount measurement system 1, it is possible to precisely obtain the amount of light received by the user.

Moreover, in received-light amount measurement system 1 according to the present embodiment, when the external device is lighting apparatus 31, controller 121 calculates a second distance between first light receiving sensor 110 and lighting apparatus 31 based on the first position information of first light receiving sensor 110 and the second position information of lighting apparatus 31, and calculates an altitude difference between first light receiving sensor 110 and lighting apparatus 31 from an altitude of first light receiving sensor 110 (an example of the first altitude) and an altitude of lighting apparatus 31 (an example of the second altitude), and when at least one of conditions is satisfied, the controller determines a third amount of received light obtained from lighting apparatus 31, as the interpolation information, and the conditions includes: the second distance being less than or equal to a second specified distance; and the altitude difference being less than or equal to a specified height.

With this configuration, controller 121 determines the third amount of received light as the interpolation information based on the second distance between first light receiving sensor 110 and lighting apparatus 31 and altitude difference H1i, and thus it is possible to prevent the third amount of received light from being determined as the interpolation information when lighting apparatus 31 is far away from first light receiving sensor 110, e.g. when lighting apparatus 31 and first light receiving sensor 110 are located on different floors.

Accordingly, in received-light amount measurement system 1, it is possible to precisely obtain the amount of light received by the user.

Moreover, in received-light amount measurement system 1 according to the present embodiment, controller 121 further calculates the third amount of received light obtained from lighting apparatus 31, based on an light output of lighting apparatus 31 and a light emission period of lighting apparatus 31.

In this manner, even if a time period exists in which the first amount of received light detected by first light receiving sensor 110 is less than or equal to the first specified value, controller 121 obtains the third amount of received light from the amount of light emitted from lighting apparatus 31 which is located in the vicinity of first light receiving sensor 110, and determines the third amount of received light as the interpolation information. Accordingly, in received-light amount measurement system 1, it is possible to precisely obtain the amount of light received by the user.

Moreover, in received-light amount measurement system 1 according to the present embodiment, when a fourth amount of received light is greater than the first specified value, controller 121 calculates a third distance based on: the first position information of first light receiving sensor 110 at a point at which the first amount, of received light is less than or equal to the first specified value; and the first position information of first light receiving sensor 110 at a point at which the fourth amount of received light is greater than the first specified value, the fourth amount of received light is received from first light receiving sensor 110 during a specified time period including the point at which the first amount of received light is less than or equal to the first specified value, and when the third distance is less than a third specified distance, controller 121 determines the fourth amount of received light as the interpolation information, the fourth amount of received light being greater than the first specified value.

In this manner, even if a time period exists in which the first amount of received light detected by first light receiving sensor 110 is less than or equal to the first specified value, controller 121 determines the fourth amount of received light, which is greater than the first specified value, as the interpolation information when the third distance calculated by controller 121 is less than the third specified distance. Accordingly, in received-light amount measurement system 1, it is possible to precisely obtain the amount of light received by the user.

Moreover, received-light amount measurement system 1 according to the present embodiment includes first wearable terminal 11 including controller 121 and light source 126 that emits light, in which controller 121 calculates a fifth amount of received light from a light output of light source 126 and a light emission period in which light source 126 emits the light, and determines a result obtained by adding the fifth amount of received light to the interpolation information, as the interpolated amount of received light obtained by first light receiving sensor 110.

In this manner, controller 121 obtains the fifth amount of received light calculated from the light output of light source 126 in first terminal device 21 and the light emission period in which light source 126 emits light, and adds the fifth amount of received light to the interpolation information. Accordingly, in received-light amount measurement system 1, it is possible to precisely obtain the amount of light received by the user.

Moreover, in received-light amount measurement system 1 according to the present embodiment, first wearable terminal 11 further includes display 123. And, when controller 121 fails to calculate the interpolated amount of received light, controller 121 causes display 123 to inform that the interpolated amount of received light fails to be calculated.

In this manner, when controller 121 fails to calculate the amount of received light, controller 121 causes display 123 to inform that the amount of received light fails to be calculated, and thus the user is informed that first light receiving sensor 110 of first wearable terminal 11 is overlapped with clothing, hair, etc., which block light.

Moreover, received-light amount measurement system 1 according to the present embodiment further includes light-irradiating apparatus 51 that emits light. And, controller 121 controls at least one of a light output of light-irradiating apparatus 51 and a light emission period of light-irradiating apparatus 51.

In this manner, controller 121 controls at least one of the light output of light-irradiating apparatus 51 and the light emission period of light-irradiating apparatus 51, and thus the light output of light-irradiating apparatus 51 is increased when the user does not receive the amount of light needed daily, and light-irradiating apparatus 51 is turned off when the user has received the amount of light needed daily. This allows the user to receive the amount of light needed daily.

### Variation 1 of Embodiment

The following describes the configuration of received-light amount measurement system 1 according to the present variation.

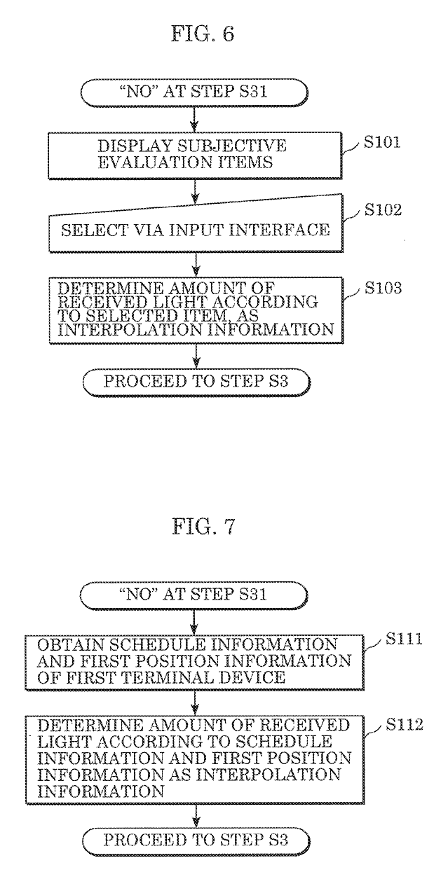

FIG. 6 is a flow chart illustrating the operation of calculating an amount of received light based on user subjective evaluation in received-light amount measurement system 1 according to variation 1 of the embodiment.

The present variation differs from the embodiment in that an amount of received light is input via display 123 based on user subjective evaluation. Moreover, unless otherwise stated received-light amount measurement system 1 according to the present variation is the same as received-light amount measurement system 1 according to the embodiment. Substantially the same structural components are assigned with the same reference signs, and redundant descriptions will be omitted or simplified.

For example, input interface 125 receives the user subjective evaluation when the amount of received light is estimated. Input interface 125 may directly receive the amount of received light from a user. The input to input interface 125 is not particularly limited.

Controller 121 calculates the amount of light received by the user during a predetermined time period based on the user subjective evaluation. Specifically, in FIG. 5, when processing proceeds from Step S1 to Step S31 and decision of Step S31 branches to “NO”, the amount of light received by the user cannot be identified. For this reason, controller 121 uses user self-evaluation to calculate the amount of light received during a time period in which the amount of received light cannot be identified.

The calculation of the amount f received light using the user self-evaluation is performed by, for example, showing to the user five subjective evaluation items of “very dim”, “slightly dim”, “neither dim nor bright”, “slightly bright”, and “very bright” to be selected, and estimating the amount of received light based on the selected subjective evaluation item. It should be noted that this subjective evaluation is merely an example, and the amount of received light may be calculated more in detail based on weather, season, time, position, etc., in a state in which the amount of light received by the user cannot be identified. Moreover, the amount of received light calculated using the subjective evaluation may be corrected based on weather, season, time, position, etc., to more precisely calculate the amount of received light. Moreover, the number of subjective evaluation items is not limited to five, but may be at most four or at least six.

The operation of first terminal device 21 according to the present variation will be described.

As illustrated in FIG. 5 and FIG. 6, firstly, when processing proceeds from Step S1 to Step S31 and decision of Step S31 branches to “NO”, controller 121 of first terminal device 21 causes display 123 of first terminal device 21 to display five subjective evaluation items (S101).

Next, the user selects from among these items via input interface 125 (S102).

Next, controller 121 determines the amount of received light according to the selected item, as the interpolation information (S103). Then, processing proceeds to Step S3 and controller 121 performs the process.

It should be noted that entry into the flow chart of FIG. 6 may be made not only after decision of Step S31 in FIG. 5 branches to “NO” but also at any time in response to a user operation. For this reason, entry into the flow chart of FIG. 6 is not limited to after decision of Step S31 in FIG. 5 branches to “NO”.

In received-light amount measurement system 1, even if any of the steps in the flow chart of FIG. 5 are not applicable, the amount of received light derived from the subjective evaluation of Steps S101 to S103 is determined as the interpolation information. Accordingly, it is possible to more precisely obtain the amount of light received by the user.

Moreover, received-light amount measurement system 1 further includes display 123 that displays an actual amount of light received by a user. And, controller 121 causes display 123 to display the actual amount of light received by the user.

Moreover, received-light amount measurement system 1 further includes display 123 that displays a plurality of items configured to be selected. And, when each of the conditions of the second distance being less than or equal to the second specified distance and the altitude difference being less than or equal to the specified height is satisfied, controller 121 determines an amount of received light selected by a user from among the plurality of items as the interpolation information.

Moreover, received-light amount measurement system 1 includes: first light receiving sensor 11 that is wearable and outputs a first amount of received light which indicates a detected amount of received light; and controller 121 that obtains information on the first amount of received light output from first light receiving sensor 11, in which when the first amount of received light is less than or equal to a first specified value, controller 121 calculates interpolation information for interpolating the first amount of received light during a time period in which the first amount of received light is less than or equal to the first specified value, and determines the interpolation information as an interpolated amount of received light obtained by first light receiving sensor 11.

The present variation produces other advantageous effects in the same manner as the embodiment.

### Variation 2 of Embodiment

The following describes the configuration of received-light amount measurement system 1 according to the present variation.

FIG. 7 is a flow chart illustrating the operation of calculating an amount of received light based on user schedule information and the first position information in received-light amount measurement system 1 according to variation 2 of the embodiment.

The present variation differs from the embodiment in that an amount of received light is calculated based on user schedule information via display 123. Moreover, unless otherwise stated, received-light amount measurement system 1 according to the present variation is the same as received-light amount measurement system 1 according to the embodiment. Substantially the same structural components are assigned with the same reference signs, and redundant descriptions will be omitted or simplified.

Controller 121 calculates the amount of received light based on at least one of schedule information and the first position information. In the present variation, the amount of received light is calculated based on both of schedule information and the first position information. For example, controller 121 calculates the amount of received light according to user activities from user activity information based on user schedule information on daily, weekly, or monthly schedule. The schedule information includes travelling to work, attending a meeting, and going out which are daily activities of the user. Controller 121 obtains the corresponding first position information of first terminal device 21 for each of the user activities, from the schedule information pre-stored in storage 124 by the user. Then, the amount of received light is calculated for each activity. The amount of received light may be calculated from a pre-set table.

In FIG. 5, when processing proceeds from Step S1 to Step S31 and decision of Step S31 branches to “NO”, controller 121 cannot identify the amount of light received by the user. For this reason, controller 121 uses the user schedule information and the first position information to calculate the amount of light received during a time period in which the amount of received light cannot be identified.

The operation of first terminal device 21 according to the present variation will be described.

As illustrated in FIG. 5 and FIG. 7, firstly, when processing proceeds from Step S1 to Step S31 and decision of Step S31 branches to “NO”, controller 121 of first terminal device 21 obtains, from storage 124, the user schedule information during a time period in which the amount of received light cannot be identified (S111). Moreover, controller 121 also obtains the first position information of first terminal device 21 during the period in which the amount of received light cannot be identified (S111).

Controller 121 associates the user schedule information with the first position information of first terminal device 21, and determines the amount of received light according to both of them as the interpolation information (S112). Then, processing proceeds to Step S3 and controller 121 performs the process.

It should be noted that entry into the flow chart of FIG. 7 may be made not only after decision of Step S31 in FIG. 5 branches to “NO” but also at any time in response to a user operation. For this reason, entry into the flow chart of FIG. 7 is not limited to after decision of Step S31 in FIG. 5 branches to “NO”.

In received-light amount measurement system 1, even if any of the steps in the flow chart of FIG. 5 are not applicable, the amount of received light derived from the user schedule information is determined as the interpolation information. Accordingly, it is possible to more precisely obtain the amount of light received by the user.

The present variation produces other advantageous effects in the same manner as the embodiment

### Other Variations

Although the received-light amount measurement system according to the present disclosure has been described on the basis of the embodiment and variations 1 and 2 of the embodiment, the present disclosure is not limited to the above-described embodiment and variations 1 and 2 of the embodiment.

For example, in the embodiment and variations 1 and 2 of the embodiment, the first wearable terminal and the first terminal device may be integrated into one apparatus. The same is true of the second wearable terminal and the second terminal device, and the third wearable terminal and the third terminal device. Moreover, the first to third, wearable terminals and the first to third terminal devices are each an example, but the wearable terminal and the terminal device are not limited to these three.

Moreover, in the embodiment and variations 1 and 2 of the embodiment, the controller may sound an alarm from a speaker, etc. when information on the first amount of received light is not received from the first wearable terminal over a predetermined time period.

Moreover, in the embodiment and variations 1 and 2 of the embodiment, the first terminal device obtains the second amount of received light from the second terminal device, but the second amount of received light may be obtained from the second wearable terminal. In this case, the second wearable terminal may obtain the second position information and transmit the second position information to the first terminal device in association with the second amount of received light.

It should be noted that the present disclosure also includes other forms in which various modifications apparent to those skilled in the art are applied to the embodiment and variations 1 and 2 of the embodiment or forms in which structural components and functions in the embodiment and variations 1 and 2 of the embodiment are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A received-light amount measurement system comprising:
a first device that is wearable and obtains a first amount of received light; and
a controller that obtains first information on the first amount of received light from the first device, wherein
when the first amount of received light is less than or equal to a first specified value, the controller calculates interpolation information for interpolating the first amount of received light during a time period in which the first amount of received light is less than or equal to the first specified value, and determines the interpolation information as an interpolated amount of received light obtained by the first device.

2. The received-light amount measurement system according to claim 1, wherein
the controller obtains second information on an amount of received light from an external device, and determines the amount of received light from the external device as the interpolation information.

3. The received-light amount measurement system according to claim 2, wherein
the external device is at least one of a second device that obtains a second amount of received light and a lighting apparatus that illuminates a space.

4. The received-light amount measurement system according to claim 3, wherein
when the external device is the second device, the controller:
calculates a first distance between the first device and the second device based on first position information of the first device and second position information of the second device;
calculates an altitude difference between the first device and the second device from a first altitude of the first device and a second altitude of the second device; and
obtains a radio field intensity of the second device from the second device,
when at least one of a plurality of conditions is satisfied, the controller determines the second amount of received light of the second device as the interpolation information, and
the plurality of conditions includes:
the first distance being less than or equal to a first specified distance;
the altitude difference being less than or equal to a specified height; and
the radio field intensity being higher than or equal to a specified intensity level.

5. The received-light amount measurement system according to claim 4, wherein
the controller further calculates a difference between the first amount of received light and the second amount of received light,
when the difference between the first amount of received light and the second amount of received light is less than or equal to a second specified value, the controller determines the first amount of received light as the interpolation information, and
when the difference between the first amount of received light and the second amount of received light is more than the second specified value, the controller determines the second amount of received light as the interpolation information.

6. The received light amount measurement system according to claim 3, wherein
when the external device is the lighting apparatus, the controller:
calculates a second distance between the first device and the lighting apparatus based on first position information of the first device and second position information of the lighting apparatus; and
calculates an altitude difference between the first device and the lighting apparatus from a first altitude of the first device and a second altitude of the lighting apparatus,
when at least one of a plurality of conditions is satisfied, the controller determines a third amount of received light obtained from the lighting apparatus, as the interpolation information, and
the plurality of conditions includes:
the second distance being less than or equal to a second specified distance; and
the altitude difference being less than or equal to a specified height.

7. The received-light amount measurement system according to claim 6, wherein
the controller further calculates the third amount of received light obtained from the lighting apparatus, based on a light output of the lighting apparatus and a light emission period of the lighting apparatus.

8. The received-light amount measurement system according to claim 6, further comprising:
a display that displays a plurality of items configured to be selected, wherein
when each of the plurality of conditions of the second distance being less than or equal to the second specified distance and the altitude difference being less than or equal to the specified height is satisfied, the controller determines an amount of received light selected by a user from among the plurality of items as the interpolation information.

9. The received-light amount measurement system according to claim 1, wherein
when a fourth amount of received light is greater than the first specified value, the controller calculates a third distance based on:
first position information of the first device at a point at which the first amount of received light is less than or equal to the first specified value; and
first position information of the first device at a point at which the fourth amount of received, light is greater than the first specified value,
the fourth amount of received light is received from the first device during a specified time period including the point at which the first amount of received light is less than or equal to the first specified value, and
when the third distance is less than a third specified distance, the controller determines the fourth amount of received light as the interpolation information, the fourth amount of received light being greater than the first specified value.

10. The received-light amount measurement system according to claim 1, further comprising:
a terminal device including the controller and a light source that emits light, wherein
the controller calculates a fifth amount of received light from a light output of the light source and a light emission period in which the light source emits the light, and determines a result obtained by adding the fifth amount of received light to the interpolation information, as the interpolated amount of received light obtained by the first device.

11. The received-light amount measurement system according to claim 10, wherein
when the controller fails to calculate the interpolated amount of received light, the controller causes the terminal device to inform that the interpolated amount of received light fails to be calculated.

12. The received-light amount measurement system according to claim 1, further comprising:
a light-irradiating apparatus that emits light, wherein
the controller controls at least one of a light output of the light-irradiating apparatus and a light emission period of the light-irradiating apparatus.

13. The received-light amount measurement system according to claim 1, further comprising;
a display that displays an actual amount of light received by a user, wherein
the controller causes the display to display the actual amount of light received by the user.

14. A received-light amount measurement system, comprising:
a light receiving sensor that is wearable and outputs an amount of received light which indicates a detected amount of received light; and
a controller that obtains information on the amount of received light output from the light receiving sensor, wherein
when the amount of received light is less than or equal to a specified value, the controller calculates interpolation information for interpolating the amount of received light during a time period in which the amount of received light is less than or equal to the specified value, and determines the interpolation information as an interpolated amount of received light obtained by the light receiving sensor.
